(19) United States
(12) Patent Application Publication
(10) Pub. No.: US 2004/0011186 A1
(43) Pub. Date: Jan. 22, 2004

(54) Device for protecting a cymbal

(76) Inventor: Charles R. Hester III, Bartlett, TN (US)

Correspondence Address: Joe D. Calhoun, Suite 205, 319 President Clinton Avenue, Little Rock, AK, 72201, US

(21) Appl. No.: 10/200,615

(22) Filed: Jul. 18, 2002

(51) Int. Cl. G10G 1/00

(52) U.S. Cl. 84/453

(57) ABSTRACT

A device for protecting a musical cymbal from scratching or other damage during transport and storage, comprising flexible planar material cloaking one surface of the cymbal, said material having a margin sufficiently elastomeric to allow said material to envelope the outer edge of the cymbal.

### CROSS REFERENCES TO RELATED APPLICATIONS

Not applicable.

### FEDERALLY SPONSORED RESEARCH OR DEVELOPMENT

Not applicable.

### MICROFICHE APPENDIX

Not applicable.

### BACKGROUND OF THE INVENTION

(1) Field of the Invention

The invention disclosed herein relate generally to protective coverings for musical instruments such as cymbals and gongs. For particularly, the present invention relates generally to coverings that protect such musical instruments from being dented, scratched or otherwise damaged when stacked one atop another, for transport or storage.

(2) Description of the Related Art Including Information Disclosed Under 37 C.F.R. 1.97 and 1.98

Known in the art are various devices for protecting musical cymbals during transport. One device essentially resembles an old fashion hat box, with a handle on one side; one or more cymbals are placed within, then the lid is closed and secured. Some versions also include a central shaft or post, upon which each cymbal is impaled (via a cymbal center hold) during storage or transport. Spacer blocks made of rubber or other non-abrasive material may also be placed between each cymbal. Photographs of these metal devices may be found at www.dwdrums.com.

Another known device includes a soft-cover case, essentially forming a pocket or slot within which each cymbal is placed. A photograph of that devices may be found at www.zildjian.com.

Following patents are arguable relevant to the invention disclosed herein:

| U.S. Patent | 1^{st} Inventor | Date |
|---|---|---|
| 5,922,980 | Arteaga | 13 Jul. 1999 |
| 5,261,846 | Hanna | 16 Nov. 1993 |
| 5,088,377 | Delecaris | 18 Feb. 1992 |
| 4,709,928 | Willingham | 1 Dec. 1987 |
| 4,241,533 | Newsome | 30 Dec. 1980 |
| 4,155,946 | Vukmirovich | 26 Sep. 1978 |

U.S. Pat. No. 5,922,980 issued to Arteaga (the “Arteaga Patent”) discloses a sound muffling drum-practice device comprised of thin circular disk of rubber (or plastic of similar flexibility and resiliency) with a centralize opening; outer edge portions of material unitary with the disk extend from the peripheral edge of the disk, between and inwardly (essentially doubling back to form a cavity within which the cymbal edge is held in gripping relation). The device disclosed in the Arteaga Patent does not protect the cymbal, especially the bell portion, from denting or scratching or similar damage.

Cymbals have several structural characteristic that are critical to their music-making performance. Although most cymbals are generally circular disks, each has physical characteristics engineered to produce a particular type and volume of sound. The center-most region is usually called the bell or cup; it is usually a concave hemisphere, often with a central opening (center hole) facilitating mounting of the cymbal on a cymbal stand. The bell determines the amount of overtones or “rings” projected by a cymbal; a larger bell produces more overtones and a longer full-body sound.

The bell flattens out and tapers toward the circumferential edge of the cymbal. The tapering region is often called the “ride area”, whereas the outer edge is called “crash area”. Each of these areas is engineered to produce essentially different sounds. When viewed in cross-section, the amount of concavity from the outer bell boundary to the circumferential edge is often called “taper”. “Tonal grooves” form periodic concentric circles on the cymbals, usually radiating out from the center hole. These facilitate the escape of sound energy from the cymbal; larger deeper tonal grooves open up the cymbal sound, whereas fine and shallow grooves produce a different and more closed sound.

Although cymbals may be made in an almost infinite variety of sizes and shapes, many have standard sizes and shapes. For example, many true cymbals have a diameter of about 14 inches, 16 inches, 18 inches, 20 inches or 22 inches. Some gongs or other types of cymbals (within the definition established herein) have diameters or dimensions of up to about 50 inches, whereas finger cymbals or bells (within the definition of cymbal herein) may have much smaller diameters or dimensions such as as small as 1 inch. Also, although most cymbals have the standard uniform tapering downward from the bell to the outer edge, one type of cymbal known as a “China cymbal” tapers downward toward the outer edge, then reverses its direction and tapers upward toward the outer edge.

Each physical characteristic of the cymbal must be protected, if the cymbal is to function properly. Care must be taken especially to prevent scratching or etching of the tonal grooves or their associated ridges. Moreover, the bell must be protected against denting and scratching, especially during transport and storage. In many instances, it is necessary or prudent to protect cymbals that remain set up on a stage or other playing area for an extended period, to protect it from an accumulation of dust, debris or fingerprints (especially fingerprints conveying oils to the surface of the tonal grooves).

### (F) BRIEF SUMMARY OF THE INVENTION

In most general terms, the invention disclosed herein comprises (includes) flexible planar material cloaking one surface of the cymbal, said material having a margin sufficiently elastomeric to allow said material to envelope the outer edge of the cymbal.

One primary object of the present invention is to provide protection for cymbals during storage and transport, to prevent scratching or other damage.

Another primary object of the present invention is to provide a cymbal protection device that is easy to manufacture and use.

Another primary object of the present invention is to provide a cymbal protection device that is easy and inexpensive to manufacture.

Another object of the invention is to provide a cymbal protection device that is easy to store when not in use.

Yet another object of the invention is to provide a cymbal protection device that can protect a wide variety of sizes and shapes of cymbals; the same sized version of the present invention will have utility protecting numerous different sizes and shapes of individual cymbals.

Yet another object of the invention is to provide a cymbal protection device that is complimentary with existing cymbal protection devices.

Other objects will be apparent from a reading of the written description disclosed herein, together with the claims.

### (G) BRIEF DESCRIPTION OF THE SEVERAL VIEWS OF THE DRAWINGS

FIG. 1 depicts a plan view of the bottom of one version of the invention, without cloaking of any musical cymbal; note the elastomeric margin (11) and the loosely flexible cloaking material (12).

FIG. 2 depicts a top plan view of another version of the invention, cloaked over the top and around and under the outer edge of a standard musical cymbal (not shown, but part of the invention); note the central hole, which may include (for example) a eyelet (15) having its perimeter reinforced with thread (13) (especially Kevlar® thread) sewn therein.

FIG. 3 depicts a bottom plan view of the invention of FIG. 2, cloaked over the top and around the outer edge of a standard musical cymbal (14, not part of the invention).

FIG. 4 depicts a side elevational view of the invention of FIG. 2; the cymbal cloaked within the invention is depicted with broken lines, although it is hidden within the invention.

FIG. 5 depicts a perspective view of the invention of FIG. 2.

FIG. 6 depicts a cross-section view of a Chinese (or China) cymbal (not part of the invention) along the diameter through the center hole, with the invention of FIG. 2 cloaked over the top and around and under the outer edge, spanning the perimetal valley (20).

FIG. 7 depicts a cross-section view of a Chinese cymbal (that is smaller than that in FIG. 6) along the diameter through the center hole, with the invention of FIG. 2 cloaked over the top and around and under the outer edge and further past the lowermost aspect (21).

FIG. 8 depicts a perspective view of a version of the invention including a grommet (23) with internally threaded bore (24), this version cloaked over the top and around and under the outer edge of a standard musical cymbal (not part of the invention).

FIG. 9 depicts a perspective view of a version of the invention including a plurality of spacers (25), this version cloaked over the top and around and under the outer edge of a standard musical cymbal (not part of the invention).

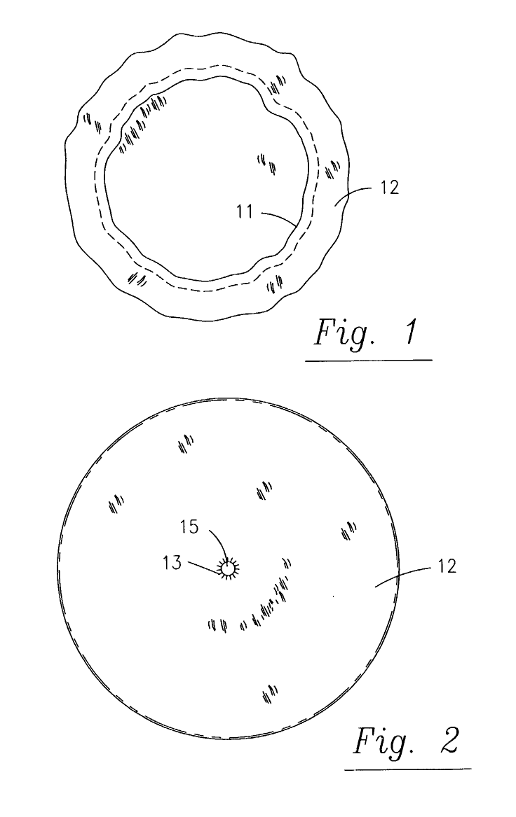

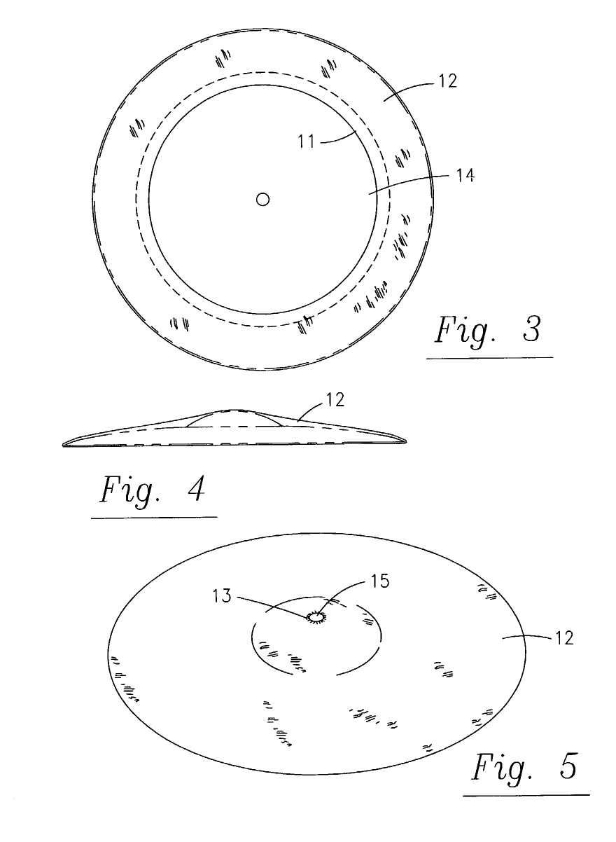

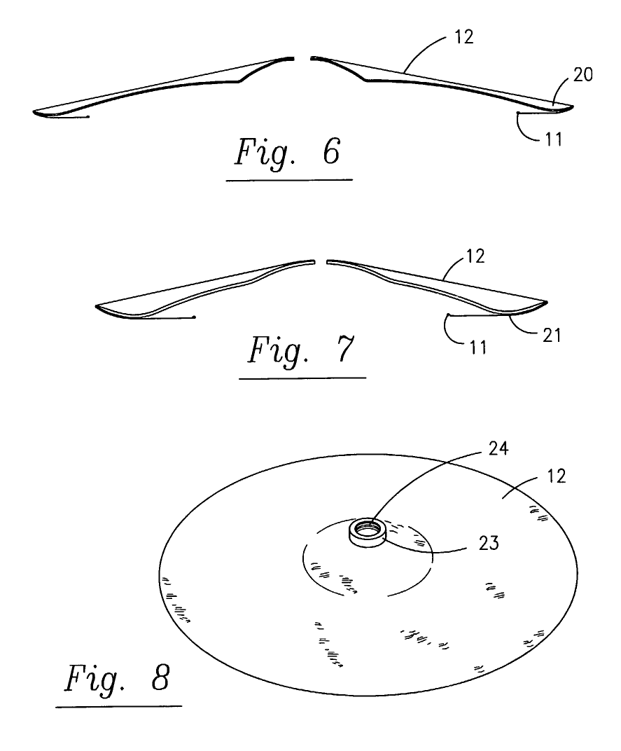

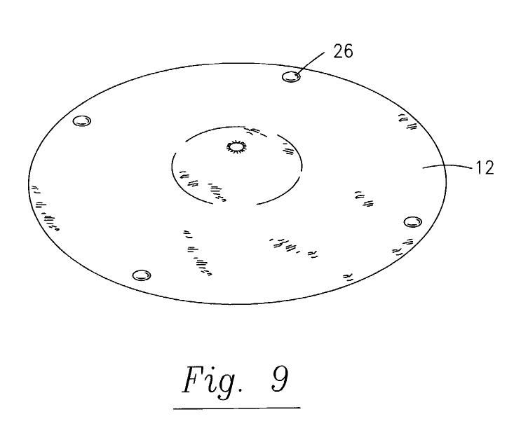

### DETAILED DESCRIPTION OF THE INVENTION

For the sake of simplicity and to give the claims of this patent application the broadest interpretation and construction possible, the following definitions will apply:

The word “cymbal” or derivative thereof essentially means a musical instrument including a centric portion surrounded by a tapering intermediate portion (often radiating therefrom) and an outer edge (often circumferential); included are types of musical instruments known as gongs, chinas, rides, crashes, splashes, high-hats and trashes, as well as instruments (often metal or alloy) that produce sound from being struck such as (for example) bells, finger cymbals, crotals, tam tams, cymbal discs and thundersheets.

The word “cloak” or derivative thereof essentially means covering without substantially binding.

The word “elastomeric” or derivative thereof essentially means capable of being stretched or bent, yet returning toward an original position.

The phrase “radial tautness” or derivative thereof essentially means lacking substantial slackness along a straight radial vector from a common center to an outer edge.

The word “veil” or derivative thereof essentially means to cloak with material having excess material adjacent a straight radial vector, such as (for example) material having folds without substantially undermining radial tautness.

The word “rip-stop” or derivative thereof essentially means capable of terminating any tearing (without fraying) quickly after commencement of any tearing.

Also for the sake of simplicity, the conjunctive “and” may also be taken to include the disjunctive “or,” and vice versa, whenever necessary to give the claims of this patent application the broadest interpretation and construction possible. Likewise, when the plural form is used, it may be taken to include the singular form, and vice versa.

The invention disclosed herein is not limited by construction materials to the extent that such materials satisfy the structural and/or functional requirements. For example, any material may be used so long as it satisfies the function for which it is being used, such as providing flexible planar material cloaking one surface of the cymbal, or having a margin sufficiently elastomeric to allow said material to envelope the outer edge of the cymbal. Such materials may include any of the following, or possibly combinations thereof: spandex or lycra, nylon, polyethylene, rubber, polyvinyl, silicon, or rip proof or rip-stop flexible fabrics or materials, and combinations thereof.

Although the invention has a number of features and variations, its most general form includes (comprises) a device for protecting a musical cymbal comprising flexible planar material cloaking one surface of the cymbal, said material having a margin sufficiently elastomeric to allow said material to envelope the outer edge of the cymbal. Often the device is essentially laid over the upper horizontal surface of the cymbal, and the outer margin stretched over and below the outer edge of the cymbal enough to maintain the cloaking on the upper surface. However, the present invention may be used on either upper or lower surface of a cymbal.

Said flexible planar material may include fabric, especially fabric that is essentially rip proof or rip-stop. This may be important because, during use, the fabric will come into contact with the outer edge of the cymbal, or the inner wall of any center hole, which may be sharp or otherwise prone to tear or cut the fabric. Versions of the fabric spandex, some marketed under the name Lycra, are especially useful.

In one version of the invention disclosed herein, said cloaking includes essentially veiling the cymbal surface. It is not necessary for the present invention to grip or pinch the cymbal being cloaked. Often such cloaking is relatively loose on the cymbal surface, within acceptable parameters of loose fitting. Often such looseness is in the form of folds. These are acceptable especially if the folds do not undermine enough radial tautness to adversely affect the overall fit and functioning of the invention.

The enveloping should include said elastomeric margin resting in a position on another surface of the cymbal, maintaining radial tautness. This is especially true in versions wherein said radial tautness facilitates or cooperates in maintaining centering of said cloaking on the cymbal. Some versions of the invention include a device further comprising other means for maintaining centering of said cloaking on any cymbal center hole. Such centering maintenance means may be selected from the group consisting of a grommet, and other materials functioning as a grommet (separating a cloaked cymbal, especially the wall of any central hole, from another adjacent cymbal) such as for example an eyelet having its perimeter reinforced with thread (especially Kevlar® thread) sewn therein, and combinations thereof.

More particularly, in one version said cloaking material defines an aperture. A grommet (essentially an annular ring having an outer circumference attached coextensively to said aperture-defining material) is positioned to correspond to the cymbal center; It should have an opening diameter at least smaller than the diameter of the opening of the cymbal center hole; this will, among other things, assure isolation between the sharp edges of the cymbal center hole and the surface of a cymbal during transport or storage. Said grommet may be constructed of material selected from the group comprising kevlar, plastic, nylon, rubber, polyvinyl and silicon, and combinations thereof. In another version of the invention, said grommet may further include an internally threaded bore. Since some existing protection devices include an externally threaded shaft protruding through the cymbal center hole, the present invention will complement such protection devices. In one version of the invention, the grommet may be an eyelet having its perimeter reinforced with Kevlar(® thread, which will rarely fray or otherwise allow damage to the cloaking material.

Yet another version of the invention includes a spacer attached to said material. A spacer may include anything that provides further separation between cymbals stacked one atop the other. The folds described herein may act as spacers. Other examples of spacers might include soft or non-abrasive material upstanding from the surface of the cloaking material, or even downstanding from the surface of the cloaking material. Ideally, this version will include a plurality of spacers attached to said material periodically in areas in contact with the intermediate area of the cymbal.

Aside from the device disclosed herein, the invention disclosed herein includes a method of making that device, including providing flexible planar material cloaking one surface of the cymbal, with a margin sufficiently elastomeric to allow said material to envelope the outer edge of the cymbal. For another version of the invention, the method may include the steps of providing flexible planar material cloaking one surface of the cymbal, with a margin sufficiently elastomeric to allow said material to envelope the outer edge of the cymbal; and providing an aperture in said device positioned to correspond to the cymbal center, and uniting said aperture-defining material with an annular ring having an outer circumference attached coextensively to said aperture-defining material, and having an opening diameter preferably equal to or less than the diameter of the opening of the cymbal center hole, and in no case substantially larger than the diameter of the opening of the cymbal center hole.

Aside from the device disclosed herein, the invention disclosed herein includes a method of using that device, including the step of cloaking one surface of the cymbal with flexible planar material including a margin sufficiently elastomeric to allow said material to envelope the outer edge of the cymbal, said elastomeric margin returning toward its resting position at another surface of the cymbal. For another version of the invention, the method may include the steps of cloaking one surface of the cymbal with flexible planar material including a margin sufficiently elastomeric to allow said material to envelope the outer edge of the cymbal; and threading said annular ring over a shaft protruding through the cymbal center hole.

The device will therefore be useful for cymbals during transport or storage. Alternatively, it will be useful for cymbals that remain set up on a stage or other playing area for an extended period, to protect it from an accumulation of dust, debris or fingerprints (especially fingerprints conveying oils to the surface of the tonal grooves).

Those skilled in the art who have the benefit of this disclosure will appreciate that it may be used as the creative basis for designing devices or methods similar to those disclosed herein, or to design improvements to the invention disclosed herein; such new or improved creations should be recognized as dependant upon the invention disclosed herein, to the extent of such reliance upon this disclosure.

I claim:

1. A device for protecting a musical cymbal comprising flexible planar material cloaking one surface of the cymbal, said material having a margin sufficiently elastomeric to allow said material to envelope the outer edge of the cymbal.

2. A device for protecting a musical cymbal as described in claim 1 hereinabove, said flexible planar material comprising fabric.

3. A device for protecting a musical cymbal as described in claim 2 hereinabove wherein said fabric is essentially rip proof.

4. A device for protecting a musical cymbal as described in claim 2 hereinabove, wherein said fabric is essentially rip-stop.

5. A device for protecting a musical cymbal as described in claim 2 hereinabove, said fabric comprising spandex.

6. A device for protecting a musical cymbal as described in claim 1 hereinabove, said cloaking comprising essentially veiling the cymbal surface.

7. A device for protecting a musical cymbal as described in claim 6 hereinabove, said veiling comprising folds.

8. A device for protecting a musical cymbal as described in claim 1 hereinabove, said enveloping comprising said elastomeric margin resting in a position on another surface of the cymbal, maintaining radial tautness.

9. A device for protecting a musical cymbal as described in claim 8 hereinabove, said radial tautness maintaining centering of said cloaking on the cymbal.

10. A device for protecting a musical cymbal as described in claim 1 hereinabove, further comprising means for maintaining centering of said cloaking on the cymbal center hole.

11. A device for protecting a musical cymbal as described in claim 10 hereinabove, said centering maintenance means comprising a grommet.

12. A device for protecting a musical cymbal as described in claim 11 hereinabove, said material defining an aperture, said grommet comprising an annular ring having an outer circumference attached coextensively to said aperture-defining material, positioned to correspond to the cymbal center and having an opening diameter not substantially larger than the diameter of the opening of the cymbal center hole.

13. A device for protecting a musical cymbal as described in claim 12 hereinabove, said grommet constructed of material selected from the group consisting of kevlar, plastic, nylon, rubber, polyvinyl and silicon, and combinations thereof.

14. A device for protecting a musical cymbal as described in claim 13 hereinabove, said grommet further defining an internally threaded bore.

15. A device for protecting a musical cymbal as described in claim 13 hereinabove, said grommet comprising a sewn eyelet.

16. A device for protecting a musical cymbal as described in claim 1 hereinabove, further comprising at least one spacer attached to said material.

17. A method of making a device for protecting a musical cymbal, comprising the step of providing flexible planar material cloaking one surface of the cymbal, with a margin sufficiently elastomeric to allow said material to envelope the outer edge of the cymbal.

18. A method of making a device described in claim 17 hereinabove, comprising the steps of
a. providing flexible planar material cloaking one surface of the cymbal, with a margin sufficiently elastomeric to allow said material to envelope the outer edge of the cymbal; and
b. providing an aperture in said device positioned to correspond to the cymbal center, and uniting said aperture-defining material with an annular ring having an outer circumference attached coextensively to said aperture-defining material, and having an opening diameter at least smaller than the diameter of the opening of the cymbal center hole.

19. A method of using a device for protecting a musical cymbal, comprising the step of cloaking
one surface of the cymbal with flexible planar material including a margin sufficiently elastomeric to allow said material to envelope the outer edge of the cymbal, said elastomeric margin returning toward its resting position at another surface of the cymbal.

20. A method of using a device as described in claim 19 hereinabove, further comprising the steps of
a. cloaking one surface of the cymbal with flexible planar material including a margin sufficiently elastomeric to allow said material to envelope the outer edge of the cymbal; and
b. threading said annular ring over a shaft protruding through the cymbal center hole.
